(19) United States
(12) Patent Application Publication
(10) Pub. No.: US 2026/0316776 A1
(43) Pub. Date: Oct. 15, 2026

(54) Devices, Systems, and Methods for Improving Driver Safety

(71) Applicant: CSAA Insurance Services, Inc., Walnut Creek, CA (US)

(72) Inventor: Chandan Mishra, Sunnyvale, CA (US)

(21) Appl. No.: 19/645,066

(22) Filed: Apr. 10, 2026

Related U.S. Application Data
(60) Provisional application No. 63/789,419, filed on Apr. 15, 2025.

(51) Int. Cl. B60W 50/12; B60Q 1/50; B60W 50/00; B60W 50/14; G06V 20/56; G06V 20/59; G10L 13/027; G10L 15/183; G10L 25/51; G10L 15/06

(52) U.S. Cl. CPC B60W 50/12; B60Q 1/544; B60W 50/0098; B60W 50/14; G06V 20/588; G06V 20/597; G10L 13/027; G10L 15/183; G10L 25/51; B60W 2050/143; B60W 2420/403; B60W 2540/21; B60W 2540/229; B60W 2720/10; G10L 15/063

(57) ABSTRACT

A method includes monitoring sensor data captured by one or more sensors associated with a vehicle. The method includes determining a driver alertness metric based on the sensor data. The method includes prompting a language model to generate conversational text in response to the driver alertness metric failing to satisfy a driver alertness threshold. The method includes outputting conversational audio to one or more speakers in the vehicle. The conversational audio is based on the conversational text. The method includes providing responsive text to the language model. The responsive text is based on speech detected by one or more microphones in the vehicle, and the speech is responsive to the conversational audio. Based at least on a response metric generated by the language model, the method includes adjusting the driver alertness metric to generate an adjusted driver alertness metric. The response metric is based at least on the responsive text.

### CROSS-REFERENCE TO RELATED APPLICATION

The present application claims the benefit of U.S. Provisional Patent Application No. 63/789,419, filed Apr. 15, 2025. The contents of which are hereby incorporated by reference in their entirety.

### FIELD OF THE DISCLOSURE

The present disclosure involves systems and methods for evaluating and improving driver alertness while the driver is operating a vehicle.

### SUMMARY

In an example, a method of evaluating driver alertness comprises monitoring, by a computing system integrated into a vehicle, sensor data captured by one or more sensors associated with the vehicle. In examples, the method includes determining, by the computing system, a driver alertness metric based on the sensor data. In examples, the method includes prompting, by the computing system, a language model to generate conversational text in response to the driver alertness metric failing to satisfy a driver alertness threshold. In examples, the language model is hosted by the computing system. In examples, the method includes outputting, by the computing system, conversational audio to one or more speakers in the vehicle. In examples, the conversational audio is based on the conversational text. In examples, the method includes providing, by the computing system, responsive text to the language model. In examples, the responsive text is based on speech detected by one or more microphones in the vehicle, and the speech is responsive to the conversational audio. In examples, based at least on a response metric generated by the language model, the method includes adjusting the driver alertness metric to generate an adjusted driver alertness metric. In examples, the response metric is based at least on the responsive text. In examples, the method includes generating a driver safety instruction based on the adjusted driver alertness metric.

In another example, a computing system includes a memory and a processor coupled to the memory. In examples, the processor is configured to monitor sensor data captured by one or more sensors associated with a vehicle. In examples, the processor is configured to determine a driver alertness metric based on the sensor data. In examples, the processor is configured to prompt a language model to generate conversational text in response to the driver alertness metric failing to satisfy a driver alertness threshold. In examples, the language model is hosted by the processor. In examples, the processor is configured to output conversational audio to one or more speakers in the vehicle. In examples, the conversational audio is based on the conversational text. In examples, the processor is configured to provide responsive text to the language model. In examples, the responsive text is based on speech detected by one or more microphones in the vehicle, and the speech is responsive to the conversational audio. In examples, based at least on a response metric generated by the language model, the processor is configured to adjust the driver alertness metric to generate an adjusted driver alertness metric. In examples, the response metric is based at least on the responsive text. In examples, the processor is configured to generate a driver safety instruction based on the adjusted driver alertness metric.

In another example, a non-transitory computer-readable medium includes instructions that, when executed by a processor of a computing system, cause the processor to perform operations. In examples, the operations include monitoring sensor data captured by one or more sensors associated with a vehicle. In examples, the operations include determining a driver alertness metric based on the sensor data. In examples, the operations include prompting a language model to generate conversational text in response to the driver alertness metric failing to satisfy a driver alertness threshold. In examples, the language model is hosted by the processor. In examples, the operations include outputting conversational audio to one or more speakers in the vehicle. In examples, the conversational audio is based on the conversational text. In examples, the operations include providing responsive text to the language model. In examples, the responsive text is based on speech detected by one or more microphones in the vehicle, and the speech is responsive to the conversational audio. In examples, based at least on a response metric generated by the language model, the operations include adjusting the driver alertness metric to generate an adjusted driver alertness metric. In examples, the response metric is based at least on the responsive text. In examples, the operations include generating a driver safety instruction based on the adjusted driver alertness metric.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a diagram of a computing system that is operable to evaluate driver alertness using machine learning, according to an example embodiment.

FIG. 2 illustrates a diagram of a system that is operable to evaluate driver alertness using machine learning, according to an example embodiment.

FIG. 3 illustrates is a diagram of a process that is operable to evaluate driver alertness using machine learning, according to an example embodiment.

FIG. 4 illustrates a method, according to an example embodiment.

FIG. 5 is a diagram of a hardware architecture that is operable to evaluate driver alertness using machine learning, according to an example embodiment.

FIG. 6 is a diagram of a processor core, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to a vehicle that includes a computing system operable to evaluate driver alertness. In particular, the computing system may utilize machine learning (e.g., a language model) to (i) generate conversational dialogue with a driver of the vehicle and (ii) evaluate an alertness of the driver based on the driver’s response (e.g., based on the driver’s participation in the conversational dialogue).

To illustrate, the computing system may monitor images and/or video captured by one or more cameras within the vehicle to generate preliminary indication of whether the driver is alert. In one scenario, a camera may be oriented towards the driver, and the computing system may process the images and/or video of the driver to determine whether the driver is displaying signs of drowsiness. As a non-limiting example, if the images and/or video indicate that driver’s eyes are closed for longer than a threshold period of time (e.g., two (2) seconds), the computing system may determine that the driver is displaying signs of drowsiness. In another scenario, a camera may be oriented towards the road, and the computing system may process the images and/or video of the road to determine the vehicle’s position relative to driving lanes on the road. As a non-limiting example, if the images and/or video indicate that the vehicle is at least partially outside of a driving lane for longer than a threshold period of time (e.g., four (4) seconds), the computing system may determine that the driver is displaying signs of drowsiness.

In response to a preliminary indication that the driver is displaying signs of drowsiness, the computing system may prompt a language model (e.g., a multi-modal large language model (LLM)) to generate conversational dialogue that can be audibly output to speakers within the vehicle to evaluate the driver’s alertness. For example, the language model can generate conversational text that, when audibly output to the driver, is intended to elicit a response from the driver. Text-to-Speech conversion logic may be used to convert the conversational text into conversational audio that is output to the speakers.

A microphone within the vehicle may detect the driver’s response to the conversational audio. In some embodiments, the driver’s response may be converted to text, using speech-to-text conversion logic, and provided to the language model for evaluation. In other embodiments, the language model may be a multi-modal model that can evaluate the driver’s response (e.g., native speech) without speech-to-text conversion (e.g., in one or more multi-modal language models that do not require speech-to-text conversion logic). In examples, the language model may generate a response metric that indicates a sufficiency of the driver’s response. For example, if the driver’s response was that of an alert driver (e.g., a thoughtful, insightful response that directly addressed the conversational dialogue), the response metric may be relatively high. However, if the driver’s response was that of a drowsy driver (e.g., short, non-responsive, and/or non-existent), the response metric may be relatively low.

The response metric may be used to determine a driver alertness metric. The driver alertness metric may have a direct relationship with the response metric. For example, a high driver alertness metric may be the result of a high response metric, and vice versa. The driver alertness metric may be used to generate and report a driver safety score. For example, if the driver alertness metric indicates that the driver is alert while driving the vehicle, a relatively high driver safety score may be generated and reported to insurance companies. However, if the driver alertness metric indicates that the driver is not alert while driving the vehicle, a relatively low driver safety score may be generated and reported to insurance companies. Insurance companies may use the driver safety score to determine whether to insure the vehicle and/or the driver, an amount of liability coverage, a deductible amount, a premium amount, etc.

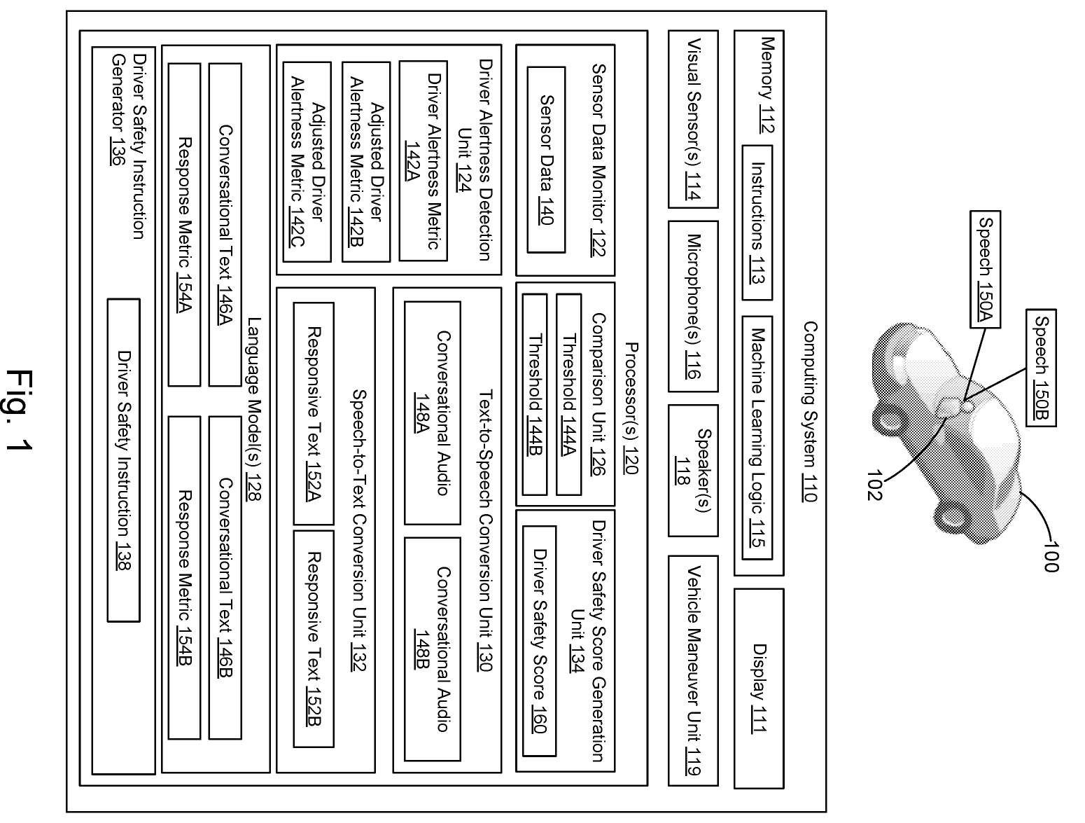

Particular implementations are described herein with reference to the figures. In the description, common features may be designated by common reference numbers throughout the figures. In some figures, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, conversational audio is illustrated and associated with reference numbers 148A and 148B. When referring to a particular one of the conversational audio, such as the conversational audio 148A, the distinguishing letter “A” is used. However, when referring to any one of the conversational audio or to the conversational audio as a group, the reference number 148 may be used without a distinguishing letter.

Referring now to the figures, FIG. 1 is a diagram of a computing system 110 that is operable to evaluate driver alertness using machine learning. The computing system 110 may be integrated into a vehicle 100. As described below, the computing system 110 may be configured to evaluate whether a driver 102 of the vehicle 100 is alert based on the driver’s 102 response to conversations generated using machine learning.

The computing system 110 includes a memory 112, a display 111, one or more visual sensors 114, one or more microphones 116, one or more speakers 118, a vehicle maneuver unit 119, and one or more processors 120 (herein referred to as “the processor 120”). The memory 112 can include one or more volatile, non-volatile, removable, and/or non-removable storage components, such as magnetic, optical, or flash storage, and/or can be integrated in whole or in part with the processor(s) 120. Further, the memory 112 can take the form of a non-transitory computer-readable storage medium, having stored thereon program instructions 113 (e.g., compiled or non-compiled program logic and/or machine code) that, when executed by the processor 120, cause the computing system 110 to perform one or more acts and/or functions, such as those described in this disclosure. As such, the computing system 110 can be configured to perform one or more acts and/or functions, such as those described in this disclosure. Such program instructions 113 can define and/or be part of a discrete software application. The memory 112 can also store other types of data, such as those types described in this disclosure. For example, as described in greater detail below, the memory 112 may also store the machine learning logic 115 that is used by the processor 120 to generate conversations.

The visual sensors 114 may be configured to capture images and/or video proximate to the vehicle 100. The images and/or video captured by the visual sensor 114 may be provided to the processor 120 as sensor data 140. In some examples, the visual sensors 114 may capture images and/or video outside of the vehicle 100. To illustrate, the visual sensors 114 may correspond to cameras that are oriented to capture surroundings of the vehicle 100. In this scenario, the sensor data 140 may include images and/or video of the vehicle’s 100 surroundings. For example, the sensor data 140 may include images and/or video of (i) a road on which the vehicle 100 is traveling, (ii) other vehicles proximate to the vehicle 100, (iii) visibility conditions, etc. Additionally, or in the alternative, the visual sensors 114 may capture images and/or video inside of the vehicle 100. To illustrates, the visual sensors 114 may correspond to cameras that are oriented to capture the driver 102. In this scenarios, the sensor data 140 may include images and/or video of the driver 102.

In examples, the processor 120 can include a general-purpose processor (e.g., a microprocessor) and/or a special-purpose processor (e.g., a digital signal processor (DSP)). The processor 120 includes a sensor data monitor 122, a driver alertness detection unit 124, a comparison unit 126, one or more language models 128 (herein referred to as “the language model 128”), a text-to-speech conversion unit 130, a speech-to-text conversion unit 132, a driver safety score generation unit 134, and a driver safety instruction generator 136. In some examples, one or more components of the processor 120 may be implemented using dedicated hardware. To illustrate, in some examples, one or more components of the processor 120 may be implemented via an application-specific integrated circuit (ASIC) or a field-programmable gate array (FPGA) device. In some examples, one or more components of the processor 120 may be implemented using software or firmware. To illustrate, in some examples, operations performed by one or more of the components of the processor 120 can be implemented by executing the instructions 113 stored in the memory 112.

The sensor data monitor 122 may be configured to monitor the sensor data 140 captured by the visual sensors 114. In examples, monitoring the sensor data 140 may include parsing through the images and/or video captured by the visual sensors 114 to identify images and/or video that may indicate the driver 102 is not alert. To illustrate, the sensor data monitor 122 may parse through the images and/or video captured by the visual sensors 114 to identify images and/or video of (i) the driver 102 closing his or her eyes for an extended period of time, (ii) the vehicle 100 positioned in multiple lanes, (iii) a low-light surrounding environment, etc. The sensor data monitor 122 may provide the sensor data 140 (indicating the driver 102 is not alert) to the driver alertness detection unit 124.

The driver alertness detection unit 124 may be configured to determine a driver alertness metric 142A based on the sensor data 140. For example, if the sensor data 140 includes images and/or video that depicts the driver’s 102 eyes closed for more than three (3) consecutive seconds, the driver alertness metric 142A may be relatively low. However, if the sensor data 140 includes images and/or video that fails to depict the driver’s 102 eyes closed for more than one (1) second, the driver alertness metric 142A may be relatively high. As another example, if the sensor data 140 includes images and/or video that depicts the vehicle 100 positioned in multiple lanes for more than five (5) consecutive seconds, the driver alertness metric 142A may be relatively low. However, if the sensor data 140 includes images and/or video that fails to depict the vehicle 100 positioned in multiple lanes for at least three (3) consecutive seconds, the driver alertness metric 142A may be relatively high. As another example, if the sensor data 140 includes images and/or video depicting a low-light surrounding environment, the driver alertness metric 142A may be relatively low.

In some scenarios, the driver alertness detection unit 124 may determine the driver alertness metric 142A based on a combination of parameters. For example, the driver alertness detection unit 124 may assign a first weighting factor to sensor data 140 depicting images and/or video of the driver 102, a second weighting factor (that is smaller than the first weighting factor) to sensor data 140 depicting images and/or video of the vehicle’s 100 position relative to lanes on a road, and a third weighting factor (that is smaller than the second weighting factor) to sensor data 140 depicting environmental lighting conditions.

In examples, the driver alertness metric 142A may be a numerical value that falls within a range of values. As an example, if the range of values is between one (1) and ten (10), the driver alertness metric 142A may be low if the numerical value is between one (1) and three (3), and the driver alertness metric 142A may be high if the numerical value is between eight (8) and ten (10).

The comparison unit 126 may be configured to compare the driver alertness metric 142A to a driver alertness threshold 144A. The driver alertness threshold 144A may correspond to a numerical value within the range of values (e.g., between one (1) and ten (10)) that, if the driver alertness metric 142A fails to satisfy (e.g., is lower than or equal to), triggers prompting of the language model 128 to evaluate driver alertness. To illustrate, if the driver alertness threshold 144A is eight (8), the driver alertness metric 142A fails to satisfy the driver alertness threshold 144A if the numerical value of the driver alertness metric 142A is between one (1) and eight (8). If the driver alertness metric 142A is greater than the driver alertness threshold 144A, prompting of the language model 128 may be bypassed and the sensor data monitor 122 may continue to monitor sensor data 140 usable by the driver alertness detection unit 124. However, for the below description, the assumption is that the driver alertness metric 142A fails to satisfy the driver alertness threshold 144A and the language model 128 is prompted as a result.

The processor 120 may be configured to prompt the language model 128 to generate conversational text 146A in response to the driver alertness metric 142A failing to satisfy the driver alertness threshold 144A. The language model 128 may be a machine learning model that is hosted by the processor 120 (e.g., hosted by the computing system 110). For example, the language model 128 may be a local language model that operates independently from a remote server or internet connection. In examples, the language model 128 may be a multi-modal large language model.

The conversational text 146A generated by the language model 128 may be formatted in such a manner as to engage the driver 102 in a person-to-person conversation. As an example, the conversational text 146A may state “I’m just curious, why do you believe that the Oklahoma City Thunder will win the NBA championship this year?” Such a statement should elicit a response from the driver 102 that may be used to evaluate the driver’s 102 alertness.

The conversational text 146A generated by the language model 128 may be based at least in part on training data used to train the language model 128. In some scenarios, the training data may be based on previously detected speech by the driver 102. For example, the microphones 116 in the vehicle 100 may have previously captured the driver 102 stating that he or she believed the Oklahoma City Thunder would win the NBA championship. This captured speech may be fed into the language model 128 as user-specific training data that can be used by the language model 128 to generate the conversational text 146A.

The language model 128 may provide the conversational text 146A to the text-to-speech conversion unit 130. The text-to-speech conversion unit 130 may be configured to convert the conversational text 146A into conversational audio 148A using text-to-speech conversion logic. The computing system 110 may be configured to output the conversational audio 148A to the speakers 118 in the vehicle 100 such that the driver 102 hears “I’m just curious, why do you believe that the Oklahoma City Thunder will win the NBA championship this year?” Thus, the conversational audio 148A output by the speakers 118 is based on the conversational text 146A generated by the language model 128.

After the conversational audio 148A is output by the speakers 118, the microphones 116 may be configured to detect (e.g., capture) speech 150A from the driver 102 that is responsive to the conversational audio 148A. As a non-limiting example, the speech 150A may be include the statement “Because Oklahoma City has the most reliable bench in the NBA and their starting lineup does not have any holes”. Once the microphones 116 capture the speech 150A, the processor 120 may provide the speech to the speech-to-text conversion unit 132. The speech-to-text conversion unit 132 may be configured to convert the speech 150A into responsive text 152A using speech-to-text conversion logic. Thus, the responsive text 152A may correspond to a textual version of the speech 150A that is responsive to the conversational audio 148A.

The processor 120 may provide the responsive text 152A to the language model 128. The language model 128 may be configured to determine a response metric 154A based on the responsive text 152A. For example, the language model 128 may evaluate the responsive text 152A (e.g., the driver’s 102 answer to the conversational text 146A) and generate a numerical value (e.g., the response metric 154A) that indicates the responsive text’s 152A sufficiency. In some examples, the response metric 154A may be a numerical value that falls within a range of values. As an example, if the range of values is between one (1) and ten (10), the response metric 154A may be low if the numerical value is between one (1) and three (3), and the response metric 154A may be high if the numerical value is between eight (8) and ten (10).

In some examples, the language model 128 may analyze the tone and speed of the speech 150A. For example, if the language model 128 is a multi-modal model that supports speech analysis, conversion of the speech 150A into the responsive text 152A may be bypassed and the language model 128 may directly evaluate the speech 150A (e.g., via one or more multi-modal language models that do not require speech-to0text conversion logic). In these examples, the response metric 154A may be indicative of the tone of the speech 150A, the speed of the speech 150A, and/or other properties of the speech 150A. In some embodiments, in addition to analyzing the tone and speed of the speech 150A, visual properties of the driver 102 may be analyzed and considered in determining the response metric 154A. As a non-limiting example, an eye scanner (e.g., a camera) can analyze the driver’s 102 eyes while responding to the conversational audio 148A. If the driver’s 102 eyes look drowsy, the value of the response metric 154A may be reduced. Other examples are possible.

For example, the numerical value of the response metric 154A may also be based on training data generated by previously detected speech of the driver 102. For example, based on previously detected speech of the driver 102, the language model 128 may be trained to predict how the driver 102 should respond to the conversational text 146A. In examples, the language model 128 may compare the responsive text 152A to the predicted response to determine the numerical value of the response metric 154A.

Based on the response metric 154A, the driver alertness detection unit 124 may be configured to adjust the driver alertness metric 142A to generate an adjusted driver alertness metric 142B. For example, if the numerical value of the response metric 154A is high (e.g., between eight (8) and ten (10)), the driver alertness detection unit 124 may increase the driver alertness metric 142A such that the adjusted driver alertness metric 142B is higher than the original driver alertness metric 142A. However, if the numerical value of the response metric 154A is low (e.g., between one (1) and three (3)), the driver alertness detection unit 124 may decrease the driver alertness metric 142A such that the adjusted driver alertness metric 142B is lower than the original driver alertness metric 142A.

The comparison unit 126 may be configured to compare the adjusted driver alertness metric 142B to a driver alertness threshold 144B. In some examples, the driver alertness threshold 144A is identical to the driver alertness threshold 144B. In other examples, the driver alertness threshold 144A is different than the driver alertness threshold 144B. For example, the driver alertness threshold 144B may be higher than the driver alertness threshold 144A.

In some examples, in response to the adjusted driver alertness metric 142B failing to satisfy the driver alertness threshold 144B, the vehicle maneuver unit 119 may be configured to perform (or initiate performance of) a vehicle maneuver operation. In examples, the vehicle maneuver operation may include stopping the vehicle 100, maneuvering the vehicle 100 to a side of a road, slowing down the vehicle 100, activating hazard lights associated with the vehicle 100, etc. In some examples, in response to the adjusted driver alertness metric 142B failing to satisfy the driver alertness threshold 144B, the computing system 110 may perform an operation to increase the alertness of the driver 102. Such operations may include increasing a radio volume, activating a car horn, etc.

Additionally, or in the alternative, the language model 128 may be configured to generate additional conversational text 146B in response to receiving the responsive text 152A. In some examples, the additional conversational text 146B may be generated if the numerical value of the response metric 154A is between an upper threshold and a lower threshold. In some examples, the additional conversational text 146B may be generated if the numerical value of the response metric 154A is below the lower threshold. In some examples, the additional conversational text 146B may be generated as a means to keep the driver 102 alert (e.g., if the response metric 154A is above the upper threshold).

The additional conversational text 146B may be responsive to the responsive text 152A. In the above example, the responsive text 152A was the statement “Because Oklahoma City has the most reliable bench in the NBA and their starting lineup does not have any holes”. Using this example, the additional conversational text 146B may include the statement “But some could argue that the Boston Celtics have a better bench than the Oklahoma City Thunder”. Such a statement should elicit an additional response from the driver 102 that may be used to evaluate the driver’s 102 alertness.

In this scenario, the additional conversational text 146B generated by the language model 128 may be based on external statistics available to the language model 128, training data based on previous speech detected by the driver 102 or other passengers, or a combination thereof. Although the language model 128 is hosted locally by the computing system 110, in some scenarios, the language model 128 may occasionally connect to the internet (or a remote server) to retrieve information (e.g., statistics) that are usable to generate the additional conversational text 146B.

The language model 128 may provide the additional conversational text 146B to the text-to-speech conversion unit 130. The text-to-speech conversion unit 130 may be configured to convert the additional conversational text 146B into conversational audio 148B using text-to-speech conversion logic. The computing system 110 may be configured to output the conversational audio 148B to the speakers 118 in the vehicle 100 such that the driver 102 hears “But some could argue that the Boston Celtics have a better bench than the Oklahoma City Thunder”. Thus, the conversational audio 148B output by the speakers 118 is based on the additional conversational text 146B generated by the language model 128.

After the conversational audio 148B is output by the speakers 118, the microphones 116 may be configured to detect (e.g., capture) speech 150B from the driver 102 that is responsive to the conversational audio 148B. As a non-limiting example, the speech 150B may be include the statement “The Boston Celtics are good, but they do not seem motivated to me this year”. Once the microphones 116 capture the speech 150B, the processor 120 may provide the speech 150B to the speech-to-text conversion unit 132. The speech-to-text conversion unit 132 may be configured to convert the speech 150B into responsive text 152B using speech-to-text conversion logic. Thus, the responsive text 152B may correspond to a textual version of the speech 150B that is responsive to the conversational audio 148B.

The processor 120 may provide the responsive text 152B to the language model 128. The language model 128 may be configured to determine a response metric 154B based on the responsive text 152B. For example, the language model 128 may evaluate the responsive text 152B (e.g., the driver’s 102 response to the conversational text 146B) and generate a numerical value (e.g., the response metric 154B) that indicates the responsive text’s 152B sufficiency. In some examples, the response metric 154B may be based on the responsive text 152A and the responsive text 152B such that the response metric 154B is indicative of all responses to the conversational text 146 generated by the language model 128.

Based on the response metric 154B, the driver alertness detection unit 124 may be configured to adjust the driver alertness metric 142B to generate an adjusted driver alertness metric 142C. The comparison unit 126 may be configured to compare the adjusted driver alertness metric 142C to the driver alertness threshold 144C. In a similar manner as described above, in some examples, in response to the adjusted driver alertness metric 142C failing to satisfy the driver alertness threshold 144B, the vehicle maneuver unit 119 may be configured to perform (or initiate performance of) a vehicle maneuver operation. In some examples, in response to the adjusted driver alertness metric 142C failing to satisfy the driver alertness threshold 144B, a notification may be sent to a central command station, and the central command station can evaluate the efficacy of the computing system’s interaction with the driver before triggering one or more responsive actions in the vehicle (e.g., one or more vehicle maneuver operations).

Additionally, or in the alternative, the driver safety score generation unit 134 may be configured to generate a driver safety score 160 based on the driver alertness metrics 142. There may be a direct relationship between the driver alertness metrics 142 and the driver safety score 160 such that higher numerical values for the driver alertness metrics 142 result in higher driver safety scores 160, and vice versa. The driver safety score 160 may be reported to insurance companies as a means to determine whether to insure the vehicle 100 and/or the driver 102, an amount of liability coverage, a deductible amount, a premium amount, etc.

Based on the driver alertness metrics 142A-142C, the driver safety instruction generator 136 may be configured to generate a driver safety instruction 138. In some examples, the driver safety instruction 138 may be a visual instruction output by the display 111 or an audio instruction output by the speaker 118. To illustrate, if the adjusted driver alertness metric 142B fails to satisfy the driver alertness threshold 144B, the driver safety instruction 138 may be a visual instruction, presented on the display 111, that states “Please pull over and rest”. Alternatively, or in addition, the driver safety instruction 138 may be an audio instruction, played out by the speaker 118, that states “Please pull over and rest”. It should be understood that the driver safety instruction 138 may include other phrases. Non-limiting examples of the driver safety instruction 138 may include “Turn off your vehicle”, “Stop driving”, “Please take the nearest exit”, etc.

In some examples, the processor 120 may determine whether the driver 102 complied with the driver safety instruction 138. For example, if the driver safety instruction 138 states “Please pull over and rest”, the processor 120 may monitor whether the vehicle 100 has come to a stop or whether the driver 102 dismissed the driver safety instruction 138. In examples, if the driver 102 complied with the driver safety instruction 138, the driver safety score generation unit 134 may increase the driver safety score 160. However, if the driver 102 fails to comply with the driver safety instruction 138, the driver safety score generation unit 134 may decrease the driver safety score 160.

In some examples, the driver safety instruction generator 136 may generate a driver safety instruction 138 in response to the adjusted driver alertness metric 142B satisfying the driver alertness threshold 144B. For example, if the adjusted driver alertness metric 142B indicates that the driver 102 is alert, the driver safety instruction 138 may state “Keep up the great work”, etc.

The techniques described with respect to FIG. 1 enable the computing system 110 to evaluate driver alertness and perform safety maneuvers when it is determined that the driver 102 is not alert. For example, the sensor data 140 may be monitored to determine the preliminary driver alertness metric 142A. If the preliminary driver alertness metric 142A indicates that the driver 102 may not be alert, the language model 128 is prompted to initiate a conversation with the driver 102. Based on the driver’s 102 participation in the conversation (e.g., based on the adequacy and promptness of the driver’s 102 responses), the computing system 110 may generate adjusted driver alertness metrics 142B, 142C that more accurately indicate whether the driver 102 is alert. If the driver 102 is not alert (e.g., if the adjusted driver alertness metrics 142, 142C fail to satisfy the driver alertness threshold 144B), the computing system 110 may initiate safety maneuvers, such as stopping the vehicle 100, slowing down the vehicle 100, etc. Additionally, if the driver 102 is not alert, the driver safety score 160 of the driver 102 may be updated, accordingly. The driver safety score 160 may be used by an insurance company as a means to determine whether to insure the vehicle 100 and/or the driver 102, an amount of liability coverage, a deductible amount, a premium amount, etc.

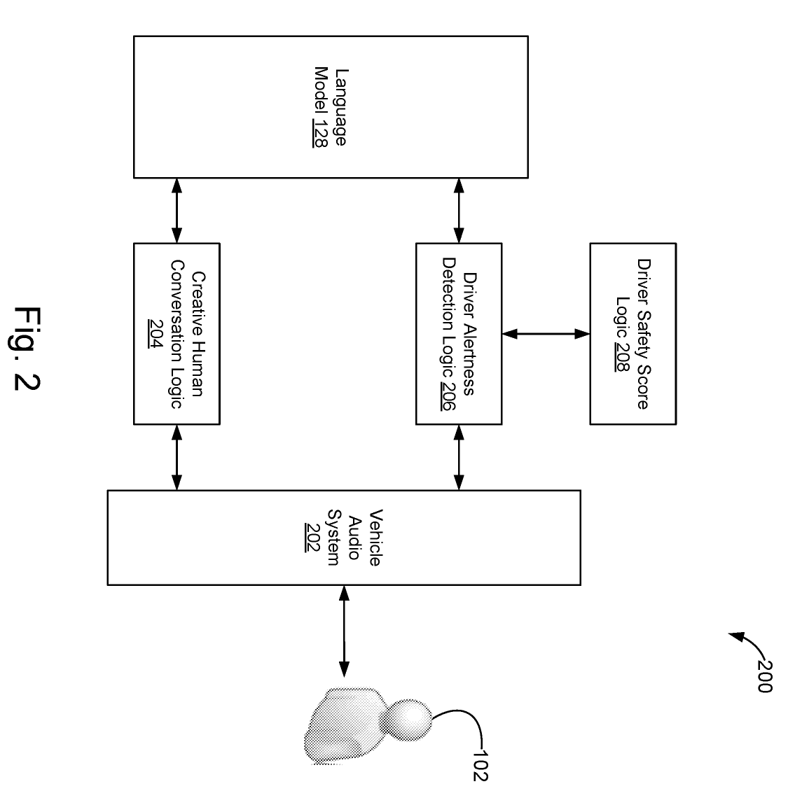

FIG. 2 is a diagram of a system 200 that is operable to evaluate driver alertness using machine learning. The system 200 includes a vehicle audio system 202, creative human conversation logic 204, the language model 128, driver alertness detection logic 206, and driver safety score logic 208. One or more components of the system 200 may be integrated into the vehicle 100. For example, one or more components of the system 200 may be integrated into the processor 120.

In examples, the vehicle audio system 202 may include the microphones 116, the speakers 118, and processing circuitry that is configured to process audio associated with the microphones 116 and the speakers 118. The driver 102 may use the vehicle audio system 202 as a mechanism to receive communications from the language model 128 and provide communications to the language model 128.

During operation, the language model 128 may be prompted to generate the conversational text 146A. The language model 128 may generate the conversational text 146A and provide the conversational text 146A to the creative human conversation logic 204. The creative human conversation logic 204 may be configured to convert the conversational text 146A into the conversational audio 148A. For example, the creative human conversation logic 204 may be integrated into the text-to-speech conversion unit 130. In some examples, the creative human conversation logic 204 may be configured to inflect different conversational tones and pronunciations into the conversational audio 148A.

The conversational audio 148A may be provided to the vehicle audio system 202, and the vehicle audio system 202 (e.g., the speakers 118) may output the conversational audio 148 to the driver 102. The vehicle audio system 202 (e.g., the microphones 116) may be configured to detect the speech 150A and provide the speech 150A to the creative human conversation logic 204.

The creative human conversation logic 204 may be configured to convert the speech 150A into the responsive text 152A. For example, the creative human conversation logic 204 may be integrated into the speech-to-text conversion unit 132. In some examples, the creative human conversation logic 204 may be configured to (i) identify different conversational tones and pronunciations in the speech 150A and (ii) generate metadata indicative of the conversational tones and pronunciations. The metadata along with the responsive text 152A may be used by the language model 128 to determine the response metric 154A.

The response metric 154A may be provided to the driver alertness detection logic 206. The driver alertness detection logic 206 may be configured to generate and/or adjust the driver alertness metric 142A based on the response metric 142A. For example, the driver alertness detection logic 206 may be integrated into the driver alertness detection unit 124.

The driver alertness metric 142A may be provided to the driver safety score logic 208. The driver safety score logic 208 may be configured to generate the driver safety score 160 based on the driver alertness metrics 142. For example, the driver safety score logic 208 may be integrated into the driver safety score generation unit 134. There may be a direct relationship between the driver alertness metrics 142 and the driver safety score 160 such that higher numerical values for the driver alertness metrics 142 result in higher driver safety scores 160, and vice versa. The driver safety score 160 may be reported to insurance companies as a means to determine whether to insure the vehicle 100 and/or the driver 102, an amount of liability coverage, a deductible amount, a premium amount, etc.

The system 200 of FIG. 2 enables alertness of the driver 102 to be evaluated using machine learning. For example, based on the driver’s 102 participation in the conversation (e.g., based on the adequacy and promptness of the driver’s 102 responses), the system 200 may generate driver alertness metrics 142 that indicate whether the driver 102 is alert. If the driver 102 is not alert, the system 200 may initiate safety maneuvers, such as stopping the vehicle 100, slowing down the vehicle 100, etc. Additionally, if the driver 102 is not alert, the driver safety score 160 of the driver 102 may be updated, accordingly. The driver safety score 160 may be used by an insurance company as a means to determine whether to insure the vehicle 100 and/or the driver 102, an amount of liability coverage, a deductible amount, a premium amount, etc.

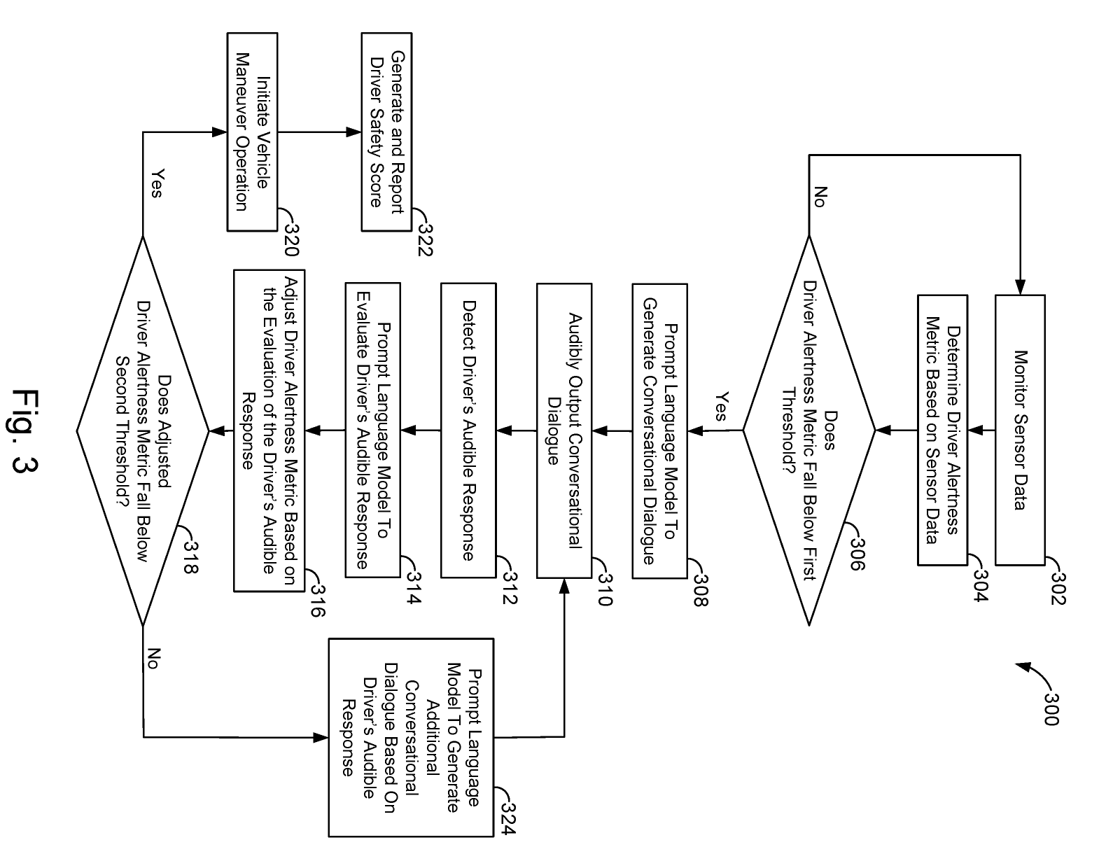

FIG. 3 is a diagram of a process 300 that is operable to evaluate driver alertness using machine learning. The process 300 may be performed by one or more components of the computing system 110.

At step 302, the process 300 includes monitoring sensor data. For example, referring to FIG. 1, the sensor data monitor 122 monitors the sensor data 140 captured by the visual sensors 114. In examples, monitoring the sensor data 140 may include parsing through the images and/or video captured by the visual sensors 114 to identify images and/or video that may indicate the driver 102 is not alert. To illustrate, the sensor data monitor 122 may parse through the images and/or video captured by the visual sensors 114 to identify images and/or video of (i) the driver 102 closing his or her eyes for an extended period of time, (ii) the vehicle 100 positioned in multiple lanes, (iii) a low-light surrounding environment, etc.

At step 304, the process 300 includes determining a driver alertness metric based on the sensor data. For example, referring to FIG. 1, the driver alertness detection unit 124 determines the driver alertness metric 142A based on the sensor data 140. To illustrate, if the sensor data 140 includes images and/or video that depicts the driver’s 102 eyes closed for more than three (3) consecutive seconds, the driver alertness metric 142A may be relatively low. However, if the sensor data 140 includes images and/or video that fails to depict the driver’s 102 eyes closed for more than one (1) second, the driver alertness metric 142A may be relatively high. As another example, if the sensor data 140 includes images and/or video that depicts the vehicle 100 positioned in multiple lanes for more than five (5) consecutive seconds, the driver alertness metric 142A may be relatively low. However, if the sensor data 140 includes images and/or video that fails to depict the vehicle 100 positioned in multiple lanes for at least three (3) consecutive seconds, the driver alertness metric 142A may be relatively high.

At decision step 306, the process 300 includes determining whether the driver alertness metric falls below a first threshold. For example, referring to FIG. 1, the comparison unit 126 compares the driver alertness metric 142A to the driver alertness threshold 144A. If the driver alertness metric 142A does not fall below the first threshold (e.g., the driver alertness threshold 144A), the process 300 returns to step 302. However, if the driver alertness metric 142A falls below the first threshold, the process 300 process to step 308.

At step 308, the process 300 includes prompting a large language model to generate conversational dialogue. For example, referring to FIG. 1, the processor 120 prompts the language model 128 to generate the conversational text 146A in response to the driver alertness metric 142A failing to satisfy the driver alertness threshold 144A. The conversational text 146A generated by the language model 128 may be formatted in such a manner as to engage the driver 102 in a person-to-person conversation.

At step 310, the process 300 includes audibly outputting the conversational dialogue. For example, referring to FIG. 1, the text-to-speech conversion unit 130 converts the conversational text 146A into the conversational audio 148A, and the computing system 110 outputs the conversational audio 148A to the speakers 118 in the vehicle 100.

At step 312, the process 300 includes detecting the driver’s audible response to the conversational dialogue. For example, referring to FIG. 1, the microphones 116 detect (e.g., capture) the speech 150A from the driver 102 that is responsive to the conversational audio 148A.

At step 314, the process 300 includes prompting the language model to evaluate the driver’s audible response. For example, referring to FIG. 1, the speech-to-text conversion unit 132 converts the speech 150A into the responsive text 152A, and the processor 120 provides the responsive text 152A to the language model 128. The language model 128 determines the response metric 154A based on the responsive text 152A. For example, the language model 128 may evaluate the responsive text 152A (e.g., the driver’s 102 answer to the conversational text 146A) and generate a numerical value (e.g., the response metric 154A) that indicates the responsive text’s 152A sufficiency.

At step 316, the process 300 includes adjusting the driver alertness metric based on the evaluation of the driver’s audible response. For example, referring to FIG. 1, based on the response metric 154A, the driver alertness detection unit 124 adjusts the driver alertness metric 142A to generate the adjusted driver alertness metric 142B.

At decision step 318, the process 300 includes determining whether the adjusted driver alertness metric falls below a second threshold. For example, referring to FIG. 1, the comparison unit 126 compares the adjusted driver alertness metric 142B to the driver alertness threshold 144B. If the adjusted driver alertness metric 142B falls below the second threshold (e.g., the driver alertness threshold 144B), the process 300 proceeds to step 320.

At step 320, the process 300 includes initiating a vehicle maneuver operation. For example, referring to FIG. 1, in response to the adjusted driver alertness metric 142B failing to satisfy the driver alertness threshold 144B, the vehicle maneuver unit 119 performs (or initiates performance of) the vehicle maneuver operation. In examples, the vehicle maneuver operation may include stopping the vehicle 100, maneuvering the vehicle 100 to a side of a road, slowing down the vehicle 100, activating hazard lights associated with the vehicle 100, etc. Additionally, or in the alternative, in some examples, in response to the adjusted driver alertness metric 142B failing to satisfy the driver alertness threshold 144B, a notification may be sent to a central command station, and the central command station evaluate the efficacy of the computing system’s interaction with the driver before triggering one or more responsive actions in the vehicle (e.g., one or more vehicle maneuver operations).

At step 322, the process 300 includes generating and reporting a driver safety score. For example, referring to FIG. 1, the driver safety score generation unit 134 generates the driver safety score 160 based on the driver alertness metrics 142. There may be a direct relationship between the driver alertness metrics 142 and the driver safety score 160 such that higher numerical values for the driver alertness metrics 142 result in higher driver safety scores 160, and vice versa. The driver safety score 160 may be reported to insurance companies as a means to determine whether to insure the vehicle 100 and/or the driver 102, an amount of liability coverage, a deductible amount, a premium amount, etc.

At decision step 318, if the adjusted driver alertness metric 142B does not fall below the second threshold, the process 300 proceeds to step 324. At step 324, the process 300 includes prompting the language model to generate additional conversational dialogue based on the driver’s audible response. For example, referring to FIG. 1, the language model 128 may generate the additional conversational text 146B in response to receiving the responsive text 152A. The process 300 may return to step 310 to audibly output the additional conversational dialogue.

The process 300 enables the computing system 110 to evaluate driver alertness and perform safety maneuvers when it is determined that the driver 102 is not alert. For example, the sensor data 140 may be monitored to determine the preliminary driver alertness metric 142A. If the preliminary driver alertness metric 142A indicates that the driver 102 may not be alert, the language model 128 is prompted to initiate a conversation with the driver 102. Based on the driver’s 102 participation in the conversation (e.g., based on the adequacy and promptness of the driver’s 102 responses), the computing system 110 may generate adjusted driver alertness metrics 142B, 142C that more accurately indicate whether the driver 102 is alert. If the driver 102 is not alert (e.g., if the adjusted driver alertness metrics 142, 142C fail to satisfy the driver alertness threshold 144B), the computing system 110 may initiate safety maneuvers, such as stopping the vehicle 100, slowing down the vehicle 100, etc. Additionally, if the driver 102 is not alert, the driver safety score 160 of the driver 102 may be updated, accordingly. The driver safety score 160 may be used by an insurance company as a means to determine whether to insure the vehicle 100 and/or the driver 102, an amount of liability coverage, a deductible amount, a premium amount, etc.

### EXAMPLE METHODS AND ASPECTS

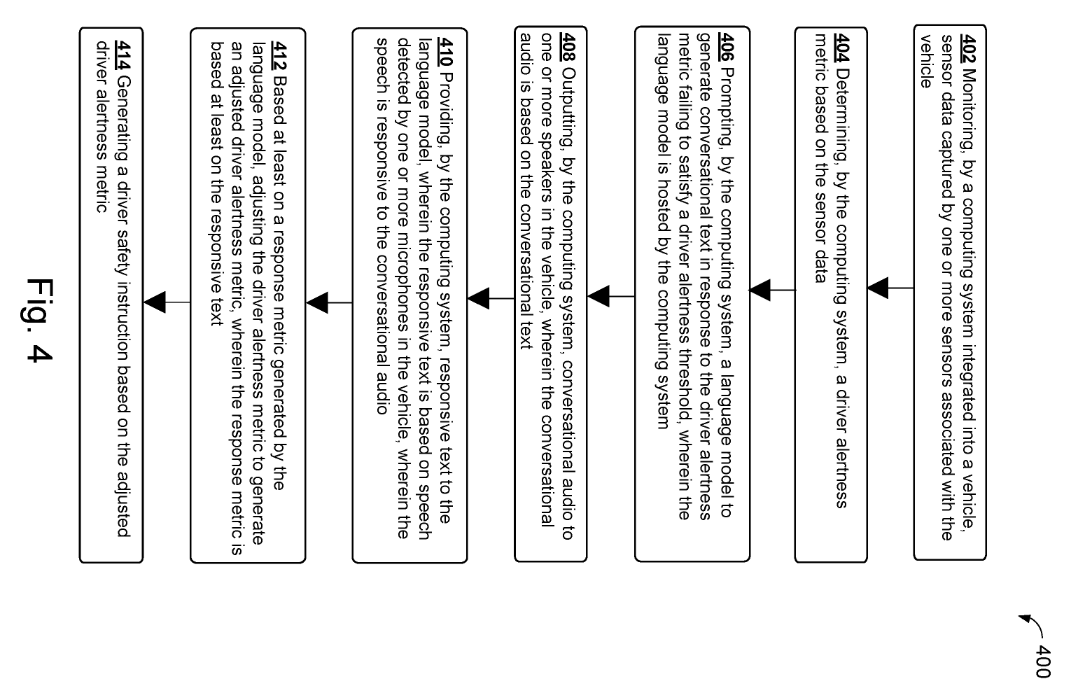

Now referring to FIG. 4, an example method of evaluating driver alertness using machine learning is disclosed.

The method 400 shown in FIG. 4 presents an example of a method that could be used with the components shown in FIGS. 1-3, for example. In other examples, components of the devices and/or systems may be arranged to be adapted to, capable of, or suited for performing the functions, such as when operated in a specific manner. The method 400 may include one or more operations, functions, or actions as illustrated by one or more of blocks 402-412. Although the blocks are illustrated in a sequential order, these blocks may also be performed in parallel, and/or in a different order than those described herein.

Also, the various blocks may be combined into fewer blocks, divided into additional blocks, and/or removed based upon the desired implementation.

At block 402, the method 400 includes monitoring, by a computing system integrated into a vehicle, sensor data captured by one or more sensors associated with the vehicle.

At block 404, the method 400 includes determining, by the computing system, a driver alertness metric based on the sensor data.

At block 406, the method 400 includes prompting, by the computing system, a language model to generate conversational text in response to the driver alertness metric failing to satisfy a driver alertness threshold. The language model is hosted by the computing system.

At block 408, the method 400 includes outputting, by the computing system, conversational audio to one or more speakers in the vehicle. The conversational audio is based on the conversational text.

At block 410, the method 400 includes providing, by the computing system, responsive text to the language model. The responsive text is based on speech detected by one or more microphones in the vehicle. The speech is responsive to the conversational audio.

At block 412, the method 400 includes, based at least on a response metric generated by the language model, adjusting the driver alertness metric to generate an adjusted driver alertness metric. The response metric is based at least on the responsive text.

At block 414, the method 400 includes generating a driver safety instruction based on the adjusted driver alertness metric. In some examples, generating the driver safety instruction comprises generating a driver safety score and an associated instruction prompt based on the adjusted driver alertness metric.

In some examples, the method 400 may include performing, by the computing system, a vehicle maneuver operation in response to the adjusted driver alertness metric failing to satisfy a second driver alertness threshold. In some examples, the driver alertness threshold is identical to the second driver alertness threshold. In some examples, the driver alertness threshold is different than the second driver alertness threshold. In some examples, the vehicle maneuver operation comprises at least one of stopping the vehicle, maneuvering the vehicle to a side of a road, slowing down the vehicle, or activating hazard lights associated with the vehicle.

In some examples of the method 400, the language model generates second conversational text in response to receiving the responsive text. In examples, the method 400 may also include outputting, by the computing system, second conversational audio to the one or more speakers in the vehicle. The second conversational audio is based on the second conversational text. In examples, the method 400 may also include providing, by the computing system, second responsive text to the language model. The second responsive text is based on second speech detected by the one or more microphones in the vehicle, and the second speech is responsive to the second conversational audio. In examples, the method 400 may include, based at least on a second response metric generated by the language model, adjusting the adjusted driver alertness metric to generate a second adjusted driver alertness metric. The second response metric is based at least on the second responsive text. In examples, the second response metric is based on the responsive text and the second responsive text.

In examples of the method 400, the language model comprises a multi-modal large language model. In examples, the language model operates independently from a remote server.

In examples, the method 400 may include generating a driver safety score based on the adjusted driver alertness metric.

In examples of the method 400, the conversational text is generated by the language model based at least in part on training data used to train the language model, and the training data is based on previously detected speech by a driver of the vehicle. In examples, the response metric is based at least in part on second training data used to train the language model, and wherein the second training is based on second previously detected speech by the driver.

In examples, the method 400 may include converting, by the computing system, the conversational text into the conversational audio using text-to-speech conversion logic. In examples, the method 400 may include converting, by the computing system, the speech into the responsive text using speech-to-text conversion logic.

In examples, the one or more sensors comprise a camera within an interior of the vehicle, and the camera is positioned to capture images or video of a driver of the vehicle.

In examples, the one or more sensors comprise a camera external to the vehicle, and the camera is positioned to capture images or video of a position of the vehicle relative to a driving lane.

The method 400 enables the computing system 110 to evaluate driver alertness and perform safety maneuvers when it is determined that the driver 102 is not alert. For example, the sensor data 140 may be monitored to determine the preliminary driver alertness metric 142A. If the preliminary driver alertness metric 142A indicates that the driver 102 may not be alert, the language model 128 is prompted to initiate a conversation with the driver 102. Based on the driver’s 102 participation in the conversation (e.g., based on the adequacy and promptness of the driver’s 102 responses), the computing system 110 may generate adjusted driver alertness metrics 142B, 142C that more accurately indicate whether the driver 102 is alert. If the driver 102 is not alert (e.g., if the adjusted driver alertness metrics 142, 142C fail to satisfy the driver alertness threshold 144B), the computing system 110 may initiate safety maneuvers, such as stopping the vehicle 100, slowing down the vehicle 100, etc. Additionally, if the driver 102 is not alert, the driver safety score 160 of the driver 102 may be updated, accordingly. The driver safety score 160 may be used by an insurance company as a means to determine whether to insure the vehicle 100 and/or the driver 102, an amount of liability coverage, a deductible amount, etc.

### EXAMPLE HARDWAR E ARCHITECTURE

Below, specialized hardware architecture is described for the techniques described with respect to FIGS. 1-4. In examples, the specialized hardware architecture improves the professing efficiency for performing the operations described with respect to FIGS. 1-4. In particular, it should be appreciated that utilizing the specialized hardware architecture increases the processing speed for performing the operations described with respect to FIGS. 1-4.

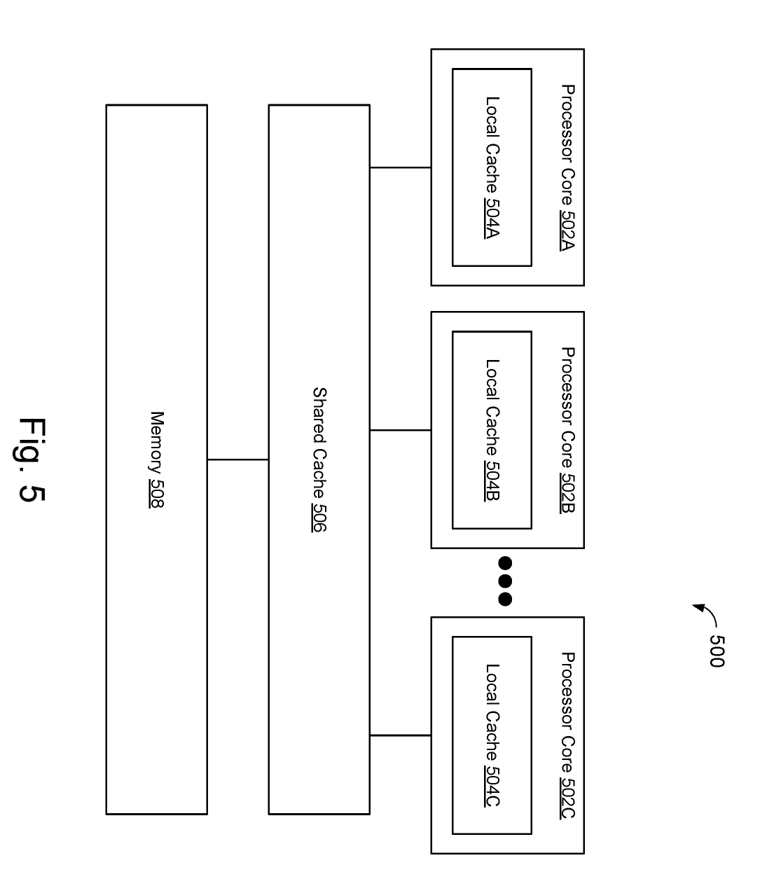

FIG. 5 is a diagram of a hardware architecture 500 that is operable to evaluate driver alertness using machine learning. In examples, the computing system 110 of FIG. 1 may be implemented using the hardware architecture 500.

As depicted in FIG. 5, the hardware architecture 500 may be a multicore processor. For example, the hardware architecture 500 includes a processor core 502A, a processor core 502B, and a processor core 502C. Although three (3) processor cores 502 are depicted, in other examples, the hardware architecture 500 includes additional (or fewer) processor cores 502. For example, in some examples, the hardware architecture 500 may include four (4) processor cores 502. In other examples, the hardware architecture 500 may include two (2) processor cores 502. In some examples, the hardware architecture 500 may be a single core processor.

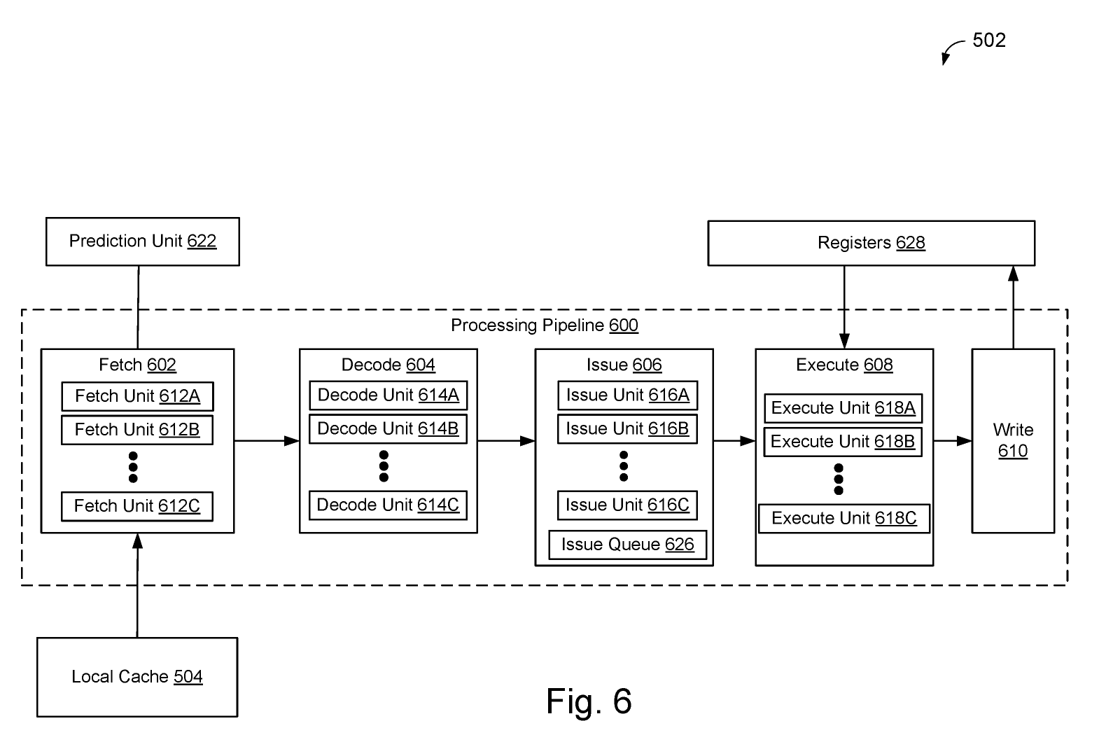

Each processor core 502 may include a local cache 504. For example, the processor core 502A may include a local cache 504A, the processor core 502B may include a local cache 504B, and the processor core 502C may include a local cache 504C. In addition to the local caches 504, each processor core 502 may include other processing resources, as described in greater detail with respect to FIG. 6. A shared cache 506 may be accessible to each processor core 502. Each processor core 502 may access a memory 508 via the shared cache 506.

In some examples, the memory 508 may correspond to the memory 112 of FIG. 1. In some examples, two or more of the processor cores 502 may correspond to the processor 120 if the processor 120 is a multicore processor. In other examples, a single processor core 502 may correspond to the processor 120 is the processor 120 is a single core processor.

FIG. 6 is a diagram of one of the processor cores 502 of the hardware architecture 500. In some examples, each processor core 502A-502C may have a similar configuration as the configuration depicted in FIG. 6. In other examples, one or more of the processor cores 502A-502 may have a different configuration.

In the example of FIG. 6, the processor core 502 includes a processing pipeline 600 for processing instructions (e.g., the instructions 113 and/or the machine learning logic 115). In some examples, the instructions processed by the processing pipeline 600 may be fetched from a memory system. The memory system may include the local cache 504, the shared cache 506, and/or the memory 508. In the example of FIG. 6, the processing pipeline 600 includes a fetch stage 602, a decode stage 604, an issue stage 606, an execute stage 608, and a write stage 610. In other examples, the processing pipeline 600 may include additional (or fewer) stages. The instructions fetched from the memory system (e.g., the local cache 504, the shared cache 506, and/or the memory 508) may pass from the fetch stage 602 to the decode stage 604, from the decode stage 604 to the issue stage 606, from the issue stage 606 to the execute stage 608, and from the execute stage 608 to the write stage 610. As a result, while one pipeline stage is processing one instruction, another pipeline stage may process a different instruction. For example, the issue stage 606 may process a first instruction while the decode stage 604 concurrently processes a second instruction.

During the fetch stage 602, the processor core 502 may be configured to fetch an instruction from the local cache 504. Although the processor core 502 is depicted as fetching an instruction from the local cache 504, in other examples, during the fetch stage 602, the processor core 502 may fetch instructions from the shared cache 506 or the memory 508. The fetch stage 602 may include multiple fetch units 612 (e.g., fetch stage slots). For example, as depicted in FIG. 6, the fetch stage 602 may include a fetch unit 612A, a fetch unit 612B, and a fetch unit 612C. Although three (3) fetch units 612 are depicted in FIG. 6, in other examples, the fetch stage 602 may include additional (or fewer) fetch units 612. To illustrate, in some examples, the fetch stage 602 may include five (5) fetch units 612. In other examples, the fetch stage 602 may include two (2) fetch units 612. Because there are multiple fetch units 612, multiple instructions may be fetched during the same cycle, which in turn, improves processing efficiency (e.g., processing speed). The fetch instructions may be passed to the decode stage 604.

In examples, the fetch stage 602 may control fetching of instructions based on predictions from a prediction unit 622 (e.g., a branch prediction unit). For example, the prediction unit 622 may be configured to predict one or more outcomes of branch instructions within program code that is executed to control the fetch stage 602. As a result, in examples, the prediction unit 622 may be configured to determine whether the next instruction to be fetched is a sequential instruction (e.g., a sequential instruction from a particular branch if the particular branch is predicted to not be taken) or an instruction at a target address if the particular branch is predicted to be taken. In some examples, the prediction unit 622 may predict the target address.

During the decode stage 604, the processor core 502 may be configured to decode the fetched instructions from the fetch stage 602. In examples, to decode the fetched instructions, the processor core 502 may identify processing operations to be performed in response to the instructions. In particular, during the decode stage 604, the processor core 502 may generate control information that controls subsequent stages to perform corresponding operations represented by the instructions. The decode stage 602 may include multiple decode units 614 (e.g., decode stage slots). For example, as depicted in FIG. 6, the decode stage 604 may include a decode unit 614A, a decode unit 614B, and a decode unit 614C. Although three (3) decode units 614 are depicted in FIG. 6, in other examples, the decode stage 604 may include additional (or fewer) decode units 614. To illustrate, in some examples, the decode stage 604 may include eight (8) decode units 614. In other examples, the decode stage 604 may include two (2) decode units 614. Because there are multiple decode units 614, multiple instructions may be decoded during the same cycle, which in turn, improves processing efficiency (e.g., processing speed).

During the issue stage 606, instructions that are awaiting execution are loaded into an issue queue 626. The processor core 502 may be configured to determine whether operands for executing the instructions will be available in time for execution at the execute stage 608. If the operands are determined to be available, during the issue stage 606, the processor core 502 may control the instructions to be issued to the execute stage 608. To illustrate, in examples, during the issue stage 606, the processor core 502 may track dependencies between instructions and issue dependent instructions once the instructions the dependent instructions depend upon have been issued. As depicted in FIG. 6, the issue stage 606 may include an issue unit 616A, an issue unit 616B, and an issue unit 616C. Although three (3) issue units 616 are depicted in FIG. 6, in other examples, the issue stage 606 may include additional (or fewer) issue units 616. To illustrate, in some examples, the issue stage 606 may include eight (8) issue units 616. In other examples, the issue stage 606 may include two (2) issue units 616. Because there are multiple issue units 616, multiple instructions may be issued during the same cycle, which in turn, improves processing efficiency (e.g., processing speed).

During the execute stage 608, a plurality of execute units 618 (e.g., execution units) may be configured to perform data processing operations in response to the instructions processed by the processing pipeline 600. As depicted in FIG. 6, the execute stage 608 may include an execute unit 618A, an execute unit 618B, and an execute unit 618C. Although three (3) execute units 616 are depicted in FIG. 6, in other examples, the execute stage 608 may include additional (or fewer) execute units 618. To illustrate, in some examples, the execute stage 608 may include eight (8) execute units 618. In other examples, the execute stage 608 may include two (2) execute units 618. Because there are multiple execute units 618, multiple instructions may be executed during the same cycle, which in turn, improves processing efficiency (e.g., processing speed). In some examples, the execute units 618 may read operands from registers 628, process the operands, and generate result values , which may be written back to the registers to during the write stage 610.

Thus, in FIG. 6, the processor core 502 may include different hardware resources to support improved processing performance for instruction execution. The hardware resources in FIG. 6 may be used to (i) monitor sensor data captured by one or more sensors associated with a vehicle (at block 402 of FIG. 4), (ii) determine a driver alertness metric based on sensor data (at block 404 of FIG. 4), (iii) prompt a language model to generate conversational text in response to the driver alertness metric failing to satisfy a driver alertness metric (at block 406 of FIG. 4), (iv) output conversational audio to one or more speakers in the vehicle (at block 408 of FIG. 4), (v) provide responsive text to the language model (at block 410 of FIG. 4), (vi) adjust the driver alertness metric to generate an adjusted driver alertness metric (at block 412 of FIG. 4), and (vii) generate a driver safety instruction based on the adjusted driver alertness metric (at block 414 of FIG. 4).

The singular forms of the articles “a,” “an,” and “the” include plural references unless the context clearly indicates otherwise. For example, the term "a compound" or "at least one compound" can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A method of evaluating driver alertness, the method comprising:
monitoring, by a computing system integrated into a vehicle, sensor data captured by one or more sensors associated with the vehicle;
determining, by the computing system, a driver alertness metric based on the sensor data;
prompting, by the computing system, a language model to generate conversational text in response to the driver alertness metric failing to satisfy a driver alertness threshold, wherein the language model is hosted by the computing system;
outputting, by the computing system, conversational audio to one or more speakers in the vehicle, wherein the conversational audio is based on the conversational text;
providing, by the computing system, responsive text to the language model, wherein the responsive text is based on speech detected by one or more microphones in the vehicle, wherein the speech is responsive to the conversational audio;
based at least on a response metric generated by the language model, adjusting the driver alertness metric to generate an adjusted driver alertness metric, wherein the response metric is based at least on the responsive text; and
generating a driver safety instruction based on the adjusted driver alertness metric.

2. The method of claim 1, further comprising performing, by the computing system, a vehicle maneuver operation in response to the adjusted driver alertness metric failing to satisfy a second driver alertness threshold.

3. The method of claim 2, wherein the driver alertness threshold is identical to the second driver alertness threshold.

4. The method of claim 2, wherein the driver alertness threshold is different than the second driver alertness threshold.

5. The method of claim 2, wherein the vehicle maneuver operation comprises at least one of stopping the vehicle, maneuvering the vehicle to a side of a road, slowing down the vehicle, or activating hazard lights associated with the vehicle.

6. The method of claim 1, wherein the language model generates second conversational text in response to receiving the responsive text, and further comprising:
outputting, by the computing system, second conversational audio to the one or more speakers in the vehicle, wherein the second conversational audio is based on the second conversational text;
providing, by the computing system, second responsive text to the language model, wherein the second responsive text is based on second speech detected by the one or more microphones in the vehicle, wherein the second speech is responsive to the second conversational audio; and
based at least on a second response metric generated by the language model, adjusting the adjusted driver alertness metric to generate a second adjusted driver alertness metric, wherein the second response metric is based at least on the second responsive text.

7. The method of claim 6, wherein the second response metric is based on the responsive text and the second responsive text.

8. The method of claim 1, wherein the language model comprises a multi-modal large language model.

9. The method of claim 1, wherein generating the driver safety instruction comprises generating a driver safety score and an associated instruction prompt based on the adjusted driver alertness metric.

10. The method of claim 1, wherein the conversational text is generated by the language model based at least in part on training data used to train the language model, and wherein the training data is based on previously detected speech by a driver of the vehicle.

11. The method of claim 10, wherein the response metric is based at least in part on second training data used to train the language model, and wherein the second training is based on second previously detected speech by the driver.

12. The method of claim 1, wherein the language model operates independently from a remote server.

13. The method of claim 1, further comprising converting, by the computing system, the conversational text into the conversational audio using text-to-speech conversion logic.

14. The method of claim 1, further comprising converting, by the computing system, the speech into the responsive text using speech-to-text conversion logic.

15. The method of claim 1, wherein the one or more sensors comprise a camera within an interior of the vehicle, wherein the camera is positioned to capture images or video of a driver of the vehicle.

16. The method of claim 1, wherein the one or more sensors comprise a camera external to the vehicle, wherein the camera is positioned to capture images or video of a position of the vehicle relative to a driving lane.

17. A computing system comprising:
a memory; and
a processor coupled to the memory, the processor configured to:
monitor sensor data captured by one or more sensors associated with a vehicle;
determine a driver alertness metric based on the sensor data;
prompt a language model to generate conversational text in response to the driver alertness metric failing to satisfy a driver alertness threshold, wherein the language model is hosted by the processor;
output conversational audio to one or more speakers in the vehicle, wherein the conversational audio is based on the conversational text;
provide responsive text to the language model, wherein the responsive text is based on speech detected by one or more microphones in the vehicle, wherein the speech is responsive to the conversational audio;
based at least on a response metric generated by the language model, adjust the driver alertness metric to generate an adjusted driver alertness metric, wherein the response metric is based at least on the responsive text; and
generate a driver safety instruction based on the adjusted driver alertness metric.

18. The computing system of claim 17, wherein the language model generates second conversational text in response to receiving the responsive text, and wherein the processor is further configured to:
output second conversational audio to the one or more speakers in the vehicle, wherein the second conversational audio is based on the second conversational text;
provide second responsive text to the language model, wherein the second responsive text is based on second speech detected by the one or more microphones in the vehicle, wherein the second speech is responsive to the second conversational audio; and
based at least on a second response metric generated by the language model, adjust the adjusted driver alertness metric to generate a second adjusted driver alertness metric, wherein the second response metric is based at least on the second responsive text.

19. The computing system of claim 17, wherein the processor is further configured to initiate performance of a vehicle maneuver operation in response to the adjusted driver alertness metric failing to satisfy a second driver alertness threshold.

20. A non-transitory computer-readable medium comprising instructions that, when executed by a processor of a computing system, cause the processor to perform operations comprising:
monitoring sensor data captured by one or more sensors associated with a vehicle;
determining a driver alertness metric based on the sensor data;
prompting a language model to generate conversational text in response to the driver alertness metric failing to satisfy a driver alertness threshold, wherein the language model is hosted by the processor;
outputting conversational audio to one or more speakers in the vehicle, wherein the conversational audio is based on the conversational text;
providing responsive text to the language model, wherein the responsive text is based on speech detected by one or more microphones in the vehicle, wherein the speech is responsive to the conversational audio;
based at least on a response metric generated by the language model, adjusting the driver alertness metric to generate an adjusted driver alertness metric, wherein the response metric is based at least on the responsive text; and
generating a driver safety instruction based on the adjusted driver alertness metric.
